(19) United States
(12) Patent Application Publication
(10) Pub. No.: US 2009/0249793 A1
(43) Pub. Date: Oct. 8, 2009

(54) Apparatus for Modifying the Content of a Gaseous Fuel

(76) Inventors: Ulf Nilsson, Leicester (GB); Peter Senior, Levittown, PA (US); Nigel Wilbraham, West Midlands (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/990,467

(22) PCT Filed: Jul. 31, 2006
(86) PCT No.: PCT/EP2006/064863

§ 371 Date: Feb. 14, 2008

(30) Foreign Application Priority Data
Aug. 27, 2005 (GB) 0517552.6

(51) Int. Cl. F02C 6/18; F23R 3/26; F02C 7/22

(52) U.S. Cl. 60/780; 60/39.23; 60/748

(57) ABSTRACT

There is described an apparatus for modifying the content of a gaseous fuel comprising: a supply of the gaseous fuel; a supply of an oxidant; and a combustion device for utilising the oxidant to partially combust a first proportion of the fuel thereby to produce products of the partial combustion including intermediate combustion products, the products of the partial combustion mixing with the remaining proportion of fuel not partially combusted thereby to provide the modified fuel, wherein the partial combustion is controlled so as to provide the intermediate combustion products required to produce a predetermined modified fuel.

### CROSS REFERENCE TO RELATED APPLICATIONS

This application is the US National Stage of International Application No. PCT/EP2006/064863, filed Jul. 31, 2006 and claims the benefit thereof. The International Application claims the benefits of Great Britain application No. 0517552.6 GB filed Aug. 27, 2005, both of the applications are incorporated by reference herein in their entirety.

### FIELD OF INVENTION

The present invention relates to an apparatus for modifying the content of a gaseous fuel.

### BACKGROUND OF INVENTION

It is known to lower the combustion temperature of gas turbine engines in order to reduce the level of undesirable by-products of the combustion, i.e. to reduce the emissions from the engine. A reduction in temperature reduces the production of NOX (nitrogen oxides). However, the reduction in temperature must not be too great otherwise this will result in an increase in production of carbon monoxide and unburned hydrocarbons.

A problem encountered with lowering the combustion temperature of a gas turbine engine is loss of the combustion flame, or flameout. In other words, reduction in combustion temperature often results in unstable combustion. If the combusted mix of fuel and air contains fuel rich pockets then such pockets do help sustain combustion when temperature is reduced. However, the level of emissions will not be as low as would be the case if the combusted mix were to be a complete and uniform mix at the reduced temperature.

### SUMMARY OF INVENTION

It is known to address this problem when using a gaseous gas turbine engine fuel, by doping or enriching the fuel with hydrogen. Hydrogen has a very high flame speed, and consequently acts to sustain the combustion flame. The hydrogen used may be derived from the fuel itself by chemical reformation of the fuel. Alternatively, bottled hydrogen may be used. The derivation of hydrogen from the fuel itself is a complex process, and consequently costly. In the case of bottled hydrogen, many bottles may be required in an environment where available space is limited.

According to a first aspect of the present invention there is provided an apparatus for modifying the content of a gaseous fuel comprising: a supply of the gaseous fuel; a supply of an oxidant; and a combustion device for utilising the oxidant to partially combust a first proportion of the fuel thereby to produce products of the partial combustion including intermediate combustion products, the products of the partial combustion mixing with the remaining proportion of fuel not partially combusted thereby to provide the modified fuel, wherein the partial combustion is controlled so as to provide the intermediate combustion products required to produce a predetermined modified fuel.

Preferably: the fuel supply comprises a passage along which the gaseous fuel flows; the oxidant supply comprises one or more inlet feeds that pass through the walls of the passage; and the combustion device is disposed substantially within the passage in the path of the flow of fuel along the passage.

Preferably, the combustion device comprises: a burner for mixing the oxidant with said first proportion of the fuel; a combustion chamber downstream of the burner in which takes place said partial combustion of the first proportion of the fuel; and an ignitor for igniting the partial combustion.

The combustion chamber may include quench holes in a downstream region of the chamber, said remaining proportion of fuel not partially combusted passing from the exterior to the interior of the chamber via the quench holes so as to quench the partial combustion in the chamber and mix with said products of the partial combustion.

The combustion chamber may include effusion holes by way of which said remaining proportion of fuel not partially combusted passes from the exterior to the interior of the chamber to cool the walls of the chamber.

In apparatus described below by way of example, the burner comprises: an upstream plate including oxidant ports that communicate with said inlet feeds; downstream of the plate a radial swirler for directing said first proportion of the fuel such that it travels generally radially inwardly and adopts a swirling motion, the radial swirler receiving oxidant from the ports of the plate to mix with the first proportion of the fuel; and downstream of the radial swirler a pre-chamber that receives the swirling flow of fuel and oxidant from the swirler.

In an apparatus described below by way of example, the upstream plate is formed so that fuel is able to pass around/through a central portion thereof, fuel impinging on the central portion to cool it prior to passing around/through the central portion to reach a central region of the radial swirler.

An apparatus described below by way of example includes a shield extension to said combustion chamber to promote mixing of said remaining proportion of fuel not partially combusted with said products of the partial combustion, the shield extension being spaced from the walls of the passage so as to be cooled by fuel that passes between the extension and the walls.

An apparatus described below by way of example includes a vortex diode located upstream of the combustion device for reducing the passage upstream of pressure pulsations and/or combustion noise caused by the device.

Preferably, said control of the partial combustion comprises control of the ratio of oxidant to fuel in the partial combustion to promote production of the intermediate combustion product carbon monoxide.

The oxidant may be air.

The gaseous fuel may include methane.

The present invention extends to a gas turbine engine including installed in its fuel supply an apparatus as aforesaid.

According to a second aspect of the present invention there is provided a method of modifying the content of a gaseous fuel comprising the steps of: utilising an oxidant to partially combust a first proportion of the gaseous fuel thereby to produce products of the partial combustion including intermediate combustion products; and mixing the products of the partial combustion with the remaining proportion of fuel not partially combusted thereby to provide the modified fuel, wherein the partial combustion is controlled so as to provide the intermediate combustion products required to produce a predetermined modified fuel.

### BRIEF DESCRIPTION OF THE DRAWINGS

The invention will now be described, by way of example, with reference to the accompanying drawings, in which:

FIG. 1 is a schematic of a first apparatus according to the present invention;

FIG. 2 is a view taken on arrow B in FIG. 1;

FIG. 3 is a view taken on arrow A in FIG. 1;

FIG. 4 is a cross-section on the line IV-IV in FIG. 1;

FIG. 5 is a schematic of a second apparatus according to the present invention;

FIG. 6 is a cross-section on the line VI-VI in FIG. 5;

FIG. 7 is a schematic of a third apparatus according to the present invention;

FIG. 8 is a schematic of a fourth apparatus according to the present invention;

FIGS. 9a, 9b and 9c are maps of carbon monoxide production in use of apparatus according to the present invention; and

FIG. 10 is a Table of the typical constituent make-up of four gaseous gas turbine engine fuels.

### DETAILED DESCRIPTION OF INVENTION

The apparatus to be described enriches a supply of the gaseous gas turbine engine fuel methane with the products of partial combustion of a proportion of the supply, including intermediate combustion products, especially carbon monoxide. The high flame speed of the carbon monoxide acts to sustain the combustion flame in subsequent combustion of the enriched fuel by the gas turbine engine. Further, carbon monoxide is particularly good at maintaining a flame at the boundary between high and low flow rates, i.e. carbon monoxide has a high strain resistance. This is a desirable property for preventing flameout in gas turbine engine combustion.

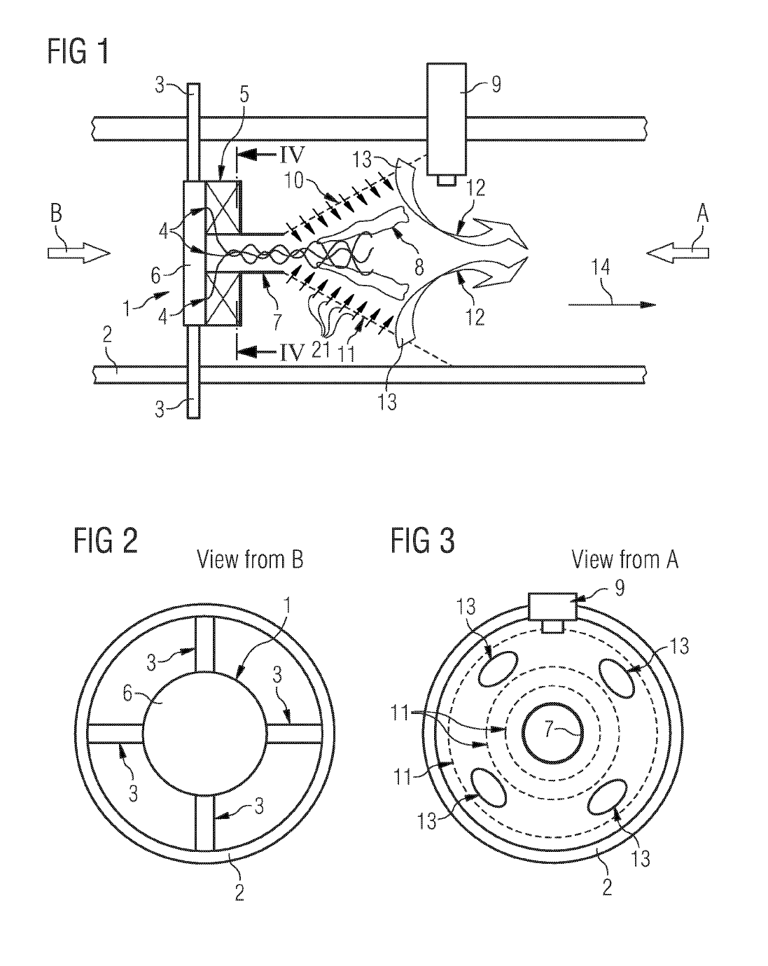

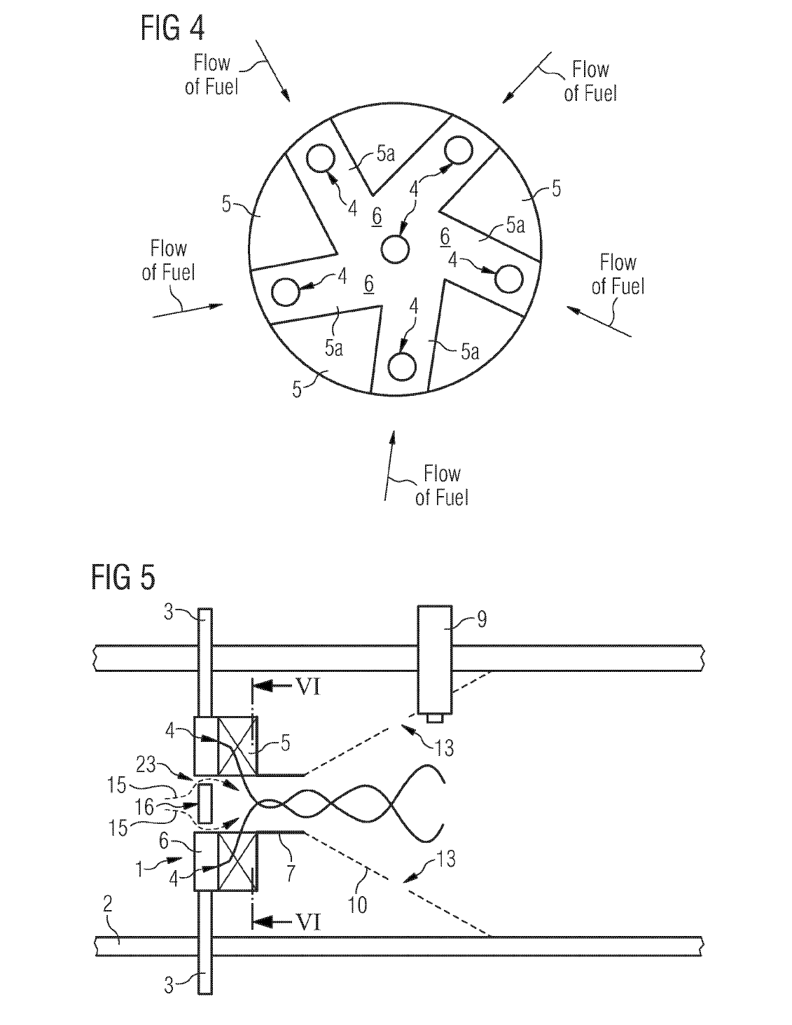

Referring to FIGS. 1 to 4, the first apparatus comprises a high pressure methane fuel supply pipe 2, air inlet feeds 3, a burner 1, a flame tube 10, and an ignitor 9. Inlet feeds 3 provide mechanical support for burner 1. Alternatively, separate supporting struts may be provided. Methane fuel flows along supply pipe 2 in the direction of arrow 14 to supply a gas turbine engine. Burner 1 comprises a front plate 6, a radial swirler 5 containing swirler passages 5a (see FIG. 4), and a pre-chamber 7.

Methane fuel flows from the left in FIG. 1, and passes between air inlet feeds 3. A proportion of the fuel enters swirler passages 5a so as to travel radially inwardly towards pre-chamber 7. The remaining proportion of the fuel continues to flow along supply pipe 2 to reach flame tube 10.

Air is supplied to air inlet feeds 3, and is injected via ports 4 in the back face of front plate 6. The fuel and air mix in the swirling flow within pre-chamber 7 in such a manner that a combustible mixture is formed in the centre of the flow away from the walls of pre-chamber 7.

This combustible mixture passes to flame tube 10. Ignitor 9 ignites initial combustion, see flame 8. Thereafter, the combustion is self-sustaining. The formation of the combustible mixture in the centre of pre-chamber 7 away from the walls of pre-chamber 7 ensures that the hot gases formed by flame 8 do not contact the walls of flame tube 10 and so do not thermally damage them. Further, effusion holes 11 are formed in the walls of flame tube 10 to enable some of the aforesaid remaining proportion of the fuel (the un-combusted proportion of the fuel) to pass through tube 10 to carry away heat radiated to tube 10 by flame 8, see arrows 21.

The supply of air via inlet feeds 3 is arranged to be insufficient for complete combustion of the fuel with which the air is mixed in pre-chamber 7. In other words, it is arranged that the air/fuel mixture in pre-chamber 7 is fuel rich so that there is only partial combustion within flame tube 10. This partial combustion gives rise to the production of intermediate combustion products, especially carbon monoxide. The insufficient supply of air also ensures that the combustion within fuel supply pipe 2 does not become uncontrollable.

The combustion within flame tube 10 is quenched by dilution jets 12 formed by the un-combusted proportion of the fuel passing through quench holes 13 in flame tube 10. The quenching also acts to mix thoroughly the un-combusted fuel with the products of the partial combustion, including carbon monoxide. Prompt quenching by dilution jets 12 minimises production of the undesirable intermediate combustion product carbon/soot (carbon takes a relatively long time to form as compared to carbon monoxide). The mixing of the hot products of the partial combustion with the un-combusted fuel cools the combustion products preventing them from becoming too hot.

The resultant carbon monoxide enriched methane fuel is then supplied to the gas turbine engine. As explained earlier, the carbon monoxide has the effect of stabilising the combustion in the gas turbine engine.

The intent is that the air/fuel mixture partially combusted in flame tube 10 is such as to produce the maximum amount of carbon monoxide.

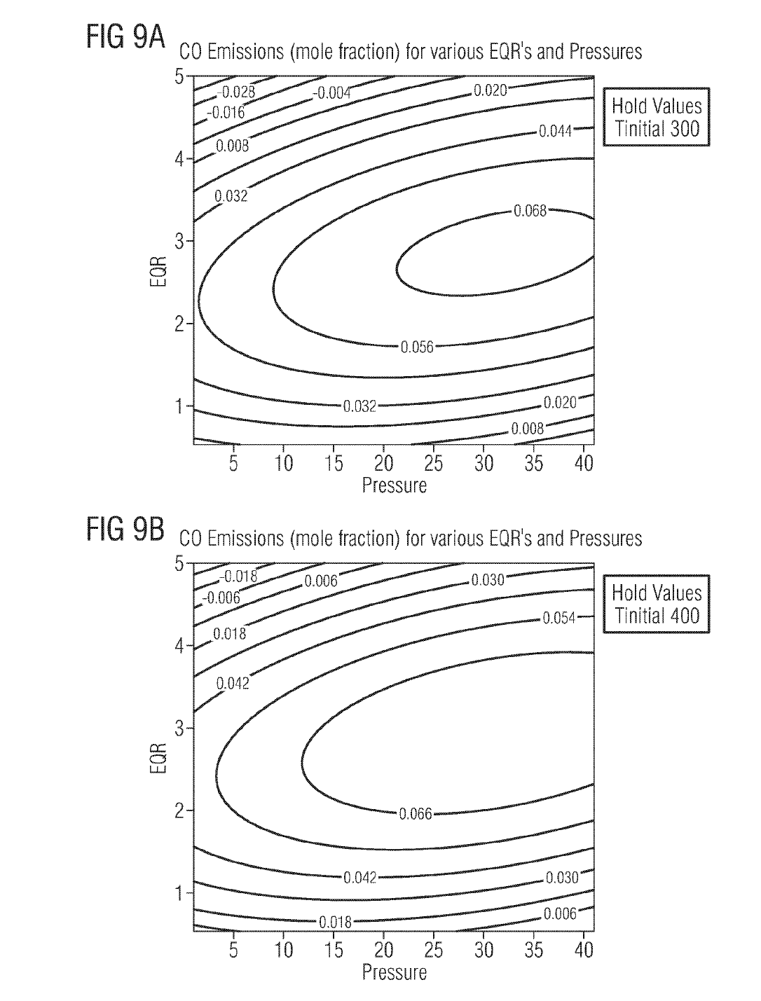

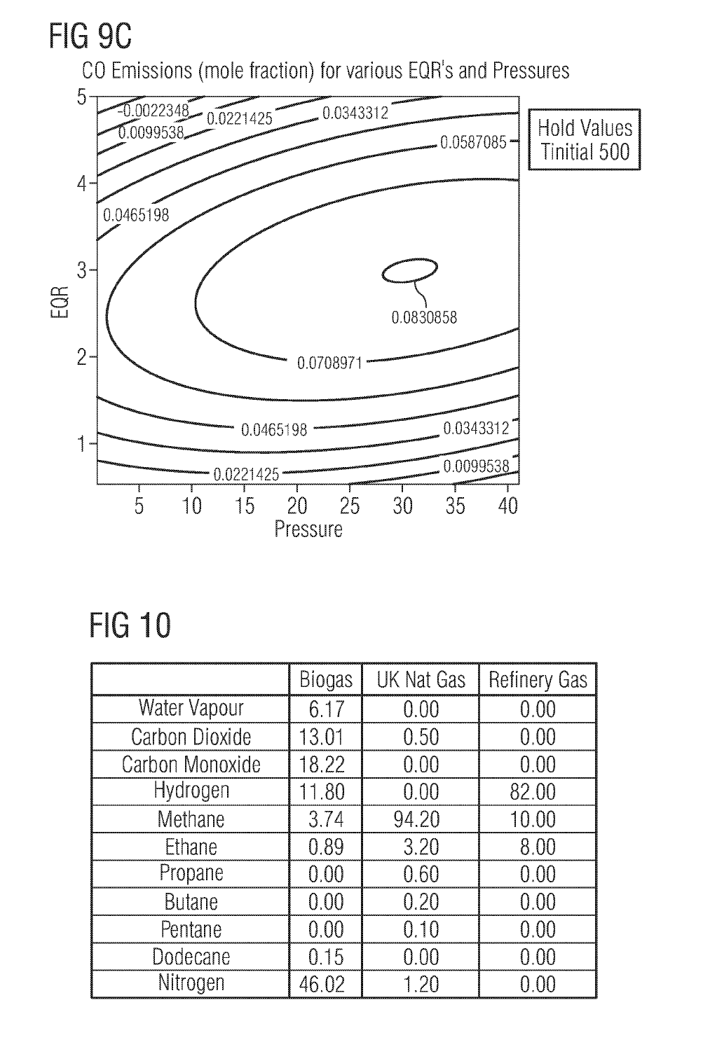

The maps of FIGS. 9a, 9b and 9c show carbon monoxide production (mole fraction) for various equivalence ratios (EQR's) and pressures. The map of FIG. 9a assumes a methane fuel temperature of 300 Kelvin, the map of FIG. 9b a fuel temperature of 400 Kelvin, and the map of FIG. 9c a fuel temperature of 500 Kelvin. The equivalence ratio (EQR) of an air/fuel mixture is defined as the ratio of fuel to air in the mixture divided by the so called stoichiometric value. The stoichiometric value is the ratio of fuel to air that produces complete (as opposed to partial) combustion. Thus, fuel rich mixtures have an EQR above one. The pressures in the maps refer to the pressure of the methane fuel supply in fuel supply pipe 2.

It can be seen that an air/fuel mixture with an EQR of approximately 2 to 3.5 tends to maximise the production of carbon monoxide over the 300 to 500 Kelvin temperature range.

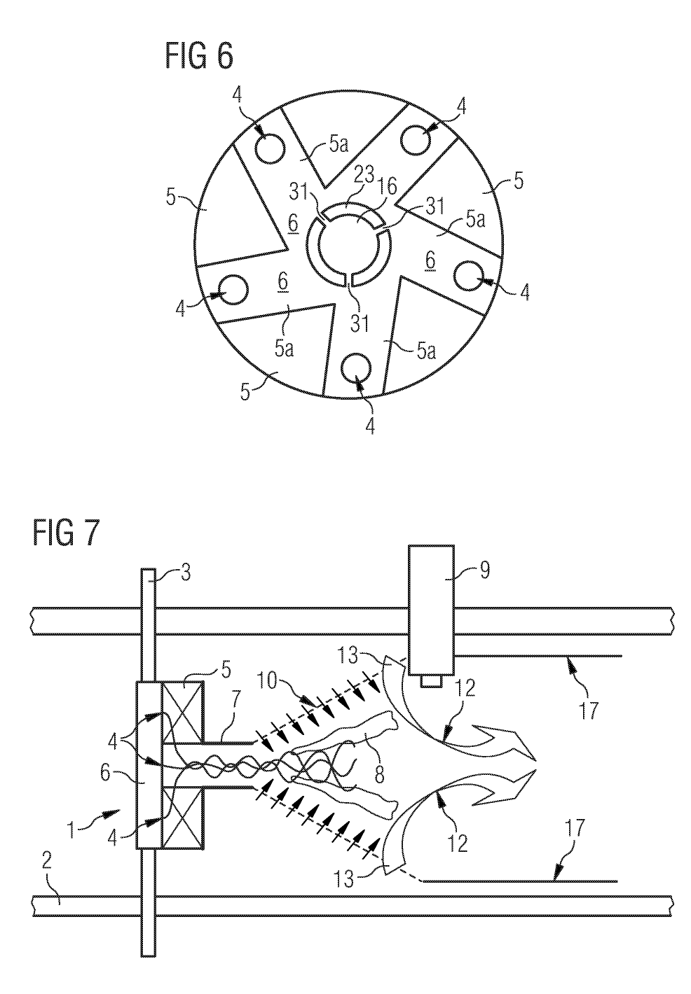

Referring to FIGS. 5 and 6, the second apparatus is the same as the first with the exception that a circular central portion 16 of front plate 6 of burner 1 is somewhat reduced in thickness, and has formed there around an annular gap 23. Central portion 16 is supported within plate 6 by support links 31, see FIG. 6. Fuel 15 impinges on the front face of central portion 16 to cool it prior to passing through annular gap 23 to mix with air in pre-chamber 7. In the alternative to an annular gap surrounding central portion 16, holes could be formed through the main body of central portion 16. Fuel would impinge on the front face of central portion 16 to cool it prior to passing through the holes to mix with air in pre-chamber 7.

Referring to FIG. 7, the third apparatus is the same as the first with the exception that a shield 17 has been added to extend flame tube 10. Shield 17 is cooled by fuel that passes between it and fuel supply pipe 2. Shield 17 is of sufficient length to ensure full mixing of the un-combusted fuel of dilution jets 12 with the partial combustion products of flame tube 10. Shield 17 ensures that no “hot spots” of partial combustion products reach the walls of fuel supply pipe 2 to weaken/corrode/burn the walls.

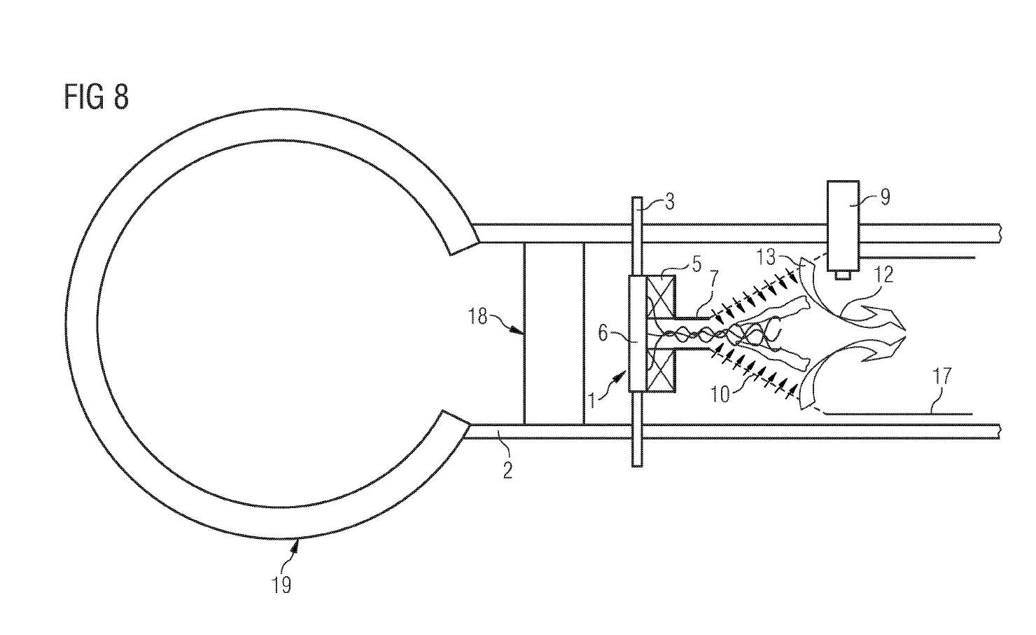

Referring to FIG. 8, the fourth apparatus is the same as the third with the exception that a vortex diode 18 has been added upstream of burner 1 for the purpose of significantly reducing the passage upstream of pressure pulsations and/or combustion noise produced by the apparatus, e.g. to avoid disturbance of similar apparatus running from the same fuel manifold 19.

In the apparatus described above by way of example, a radial swirler mixes a proportion of a supply of gaseous fuel with air so as to create a fuel rich mixture for partial combustion. It is to be appreciated that this mixing need not be carried out utilising a radial swirler. For example, the mixing could be carried out by an axial swirler, or by a mixing device other than a swirler.

The apparatus described above by way of example enrich the gas turbine engine fuel pure methane with carbon monoxide. It is of course the case that in actual commercial use of the apparatus, the gas turbine engine fuel enriched would not be pure methane, but would be a commercial gas turbine engine fuel. The following are examples of three commercial gas turbine engine fuels: Biogas, UK Natural Gas, and Refinery Gas. The Table of FIG. 10 gives the typical constituent make-up of these three fuels. The amounts in the Table are in percent by volume.

In the apparatus described above by way of example, a proportion of a gaseous fuel is taken, partially combusted, and then mixed with the remaining proportion not partially combusted to provide the final fuel. The partial combustion is controlled to promote production of the intermediate combustion product carbon monoxide such that the final fuel is carbon monoxide enriched thereby to have enhanced combustion stability. However, it is to be appreciated that the partial combustion may be controlled to promote production of a different intermediate combustion product to enhance combustion stability. In this regard, it is to be understood that the intent of the partial combustion is to provide intermediate combustion products in which the available chemical bond valency is not fully filled. Such products are highly reactive and hence have a high flame speed and strain resistance, see mention of this earlier as regards carbon monoxide. Further, such products are also capable of weakening or “stealing” the bonds of the molecules of the un-combusted fuel, increasing the reactivity of these molecules. It is also to be noted that the final enriched fuel is at a raised temperature due to the partial combustion. This increased temperature also increases the reactivity of the fuel.

It is also to be understood that the present invention has the desirable effect of reducing the amount of fuel-bound nitrogen (FBN) present in the fuel, by reducing the FBN to N₂. Although gaseous fuel usually has very little FBN, a reduction in the amount of FBN that is present is of use when endeavouring to obtain ultra or extremely low emissions from the fuel.

The apparatus described above by way of example enrich a gaseous fuel for supply to a gas turbine engine. It is to be appreciated that the present invention could be utilised to enrich a gaseous fuel for supply to a reciprocating internal combustion engine, where it is required/desirable to increase the bum rate of the fuel in the engine.

1.-16. (canceled)

17. An apparatus for modifying the content of a gaseous fuel comprising:
a supply of the gaseous fuel;
a supply of an oxidant; and
a combustion device for utilising the oxidant to partially combust a first proportion of the fuel thereby to produce products of the partial combustion including intermediate combustion products, the products of the partial combustion mixing with the remaining proportion of fuel not partially combusted thereby to provide the modified fuel, wherein the partial combustion is controlled so as to provide the intermediate combustion products required to produce a predetermined modified fuel.

18. The apparatus according to claim 17, wherein
the fuel supply comprises a passage along which the gaseous fuel flows, the oxidant supply comprises one or more inlet feeds that pass through the walls of the passage, and
the combustion device is disposed substantially within the passage in the path of the flow of fuel along the passage.

19. The apparatus according to claim 18, wherein the combustion device has a burner for mixing the oxidant with said first proportion of the fuel,
a combustion chamber downstream of the burner in which takes place said partial combustion of the first proportion of the fuel, and
an ignitor for igniting the partial combustion.

20. The apparatus according to claim 19, wherein the combustion chamber includes quench holes in a downstream region of the chamber, said remaining proportion of fuel not partially combusted passing from the exterior to the interior of the chamber via the quench holes so as to quench the partial combustion in the chamber and mix with said products of the partial combustion.

21. The apparatus according to claim 19, wherein the combustion chamber includes effusion holes by way of which said remaining proportion of fuel not partially combusted passes from the exterior to the interior of the chamber to cool the walls of the chamber.

22. The apparatus according to claim 19, wherein the burner has
an upstream plate including oxidant ports that communicate with said inlet feeds,
downstream of the plate a radial swirler for directing said first proportion of the fuel such that it travels generally radially inwardly and adopts a swirling motion, the radial swirler receiving oxidant from the ports of the plate to mix with the first proportion of the fuel, and
downstream of the radial swirler a pre-chamber that receives the swirling flow of fuel and oxidant from the swirler.

23. The apparatus according to claim 22, wherein the upstream plate is formed so that fuel is able to pass around/through a central portion thereof, fuel impinging on the central portion to cool it prior to passing around/through the central portion to reach a central region of the radial swirler.

24. The apparatus according to claim 18, further comprising a shield extension to a combustion chamber to promote mixing of said remaining proportion of fuel not partially combusted with said products of the partial combustion, the shield extension being spaced from the walls of the passage so as to be cooled by fuel that passes between the extension and the walls.

25. The apparatus according to claim 18, further comprising a vortex diode located upstream of the combustion device for reducing the passage upstream of pressure pulsations and/or combustion noise caused by the device.

26. The apparatus according to claim 17, wherein said control of the partial combustion comprises control of the ratio of oxidant to fuel in the partial combustion to promote production of the intermediate combustion product carbon monoxide.

27. The apparatus according to claim 17, wherein said oxidant is air.

28. The apparatus according to claim 17, wherein said gaseous fuel is a gas turbine engine fuel.

29. The apparatus according to claim 17, wherein said gaseous fuel includes methane.

30. The apparatus according to claim 17, wherein said gaseous fuel is a reciprocating internal combustion engine fuel.

31. A gas turbine engine, comprising:
a fuel supply; and
an apparatus having:
a supply of the gaseous fuel,
a supply of an oxidant, and
a combustion device for utilising the oxidant to partially combust a first proportion of the fuel thereby to produce products of the partial combustion including intermediate combustion products, the products of the partial combustion mixing with the remaining proportion of fuel not partially combusted thereby to provide the modified fuel, wherein the partial combustion is controlled so as to provide the intermediate combustion products required to produce a predetermined modified fuel.

32. The gas turbine engine according to claim 31, wherein
the fuel supply comprises a passage along which the gaseous fuel flows,
the oxidant supply comprises one or more inlet feeds that pass through the walls of the passage,
the combustion device is disposed substantially within the passage in the path of the flow of fuel along the passage, and
the combustion device has
a burner for mixing the oxidant with said first proportion of the fuel;
a combustion chamber downstream of the burner in which takes place said partial combustion of the first proportion of the fuel; and
an ignitor for igniting the partial combustion.

33. The gas turbine engine according to claim 32, wherein said control of the partial combustion comprises control of the ratio of oxidant to fuel in the partial combustion to promote production of the intermediate combustion product carbon monoxide.

34. The gas turbine engine according to claim 33, wherein said oxidant is air.

35. The gas turbine engine according to claim 34, wherein said gaseous fuel is a gas turbine engine fuel, wherein said gaseous fuel includes methane, and wherein said gaseous fuel is a reciprocating internal combustion engine fuel.

36. A method of modifying the content of a gaseous fuel comprising:
utilising an oxidant to partially combust a first proportion of the gaseous fuel thereby to produce products of the partial combustion including intermediate combustion products; and
mixing the products of the partial combustion with the remaining proportion of fuel not partially combusted thereby to provide the modified fuel, wherein the partial combustion is controlled so as to provide the intermediate combustion products required to produce a predetermined modified fuel.
